(19) United States
(12) Patent Application Publication
(10) Pub. No.: US 2015/0067983 A1
(43) Pub. Date: Mar. 12, 2015

(54) MULTI-SEGMENTED LIVING HINGE

(71) Applicants: Mark Carey, Upper Sandusky, OH (US); James Mills, Fremont, OH (US); Richard Knaggs, Fort Wayne, IN (US)

(72) Inventors: Mark Carey, Upper Sandusky, OH (US); James Mills, Fremont, OH (US); Richard Knaggs, Fort Wayne, IN (US)

(73) Assignee: THE PLASTICS GROUP, INC., Willowbrook, IL (US)

(21) Appl. No.: 14/482,724

(22) Filed: Sep. 10, 2014

Related U.S. Application Data
(60) Provisional application No. 61/877,078, filed on Sep. 12, 2013.
(60) Provisional application No. 61/909,112, filed on Nov. 26, 2013.

(51) Int. Cl. E05D 1/02; B29C 49/04

(52) U.S. Cl. CPC E05D 1/02; B29C 49/04; B29L 2031/22
USPC 16/225; 264/536

(57) ABSTRACT

A flexible structure is provided that includes multiple members and a hinge set providing a connection between adjacent members. The hinge set includes at least one living hinge where multiple living hinges are separated by segment portions that collapse on each other when the hinge set is in a closed position.

### CROSS-REFERENCE TO RELATED APPLICATIONS

This application claims the benefit of U.S. Provisional Patent Application Ser. Nos. 61/877,078 and 61/909,112 both entitled “LIVING HINGE” filed on and Sep. 12, 2013 and Nov. 26, 2013 respectively. The entireties of the above-noted applications are incorporated by reference herein.

### ORIGIN

The innovation disclosed herein relates to a hinge and more specifically to a living hinge.

### BACKGROUND

Conventional plastic formed “living hinges” are simple, “in forming action” direction portions of the mold/tooling and are intend only to provide the desired kinematic action in an axis parallel to this forming action (“parting line/mold split”) of the part being made.

In addition, forming a flexible structure that incorporates a living hinge provides a challenge in that during the process, if the desired structure were to include additional parts, these parts would be added (in-mold-inserted) by hand just prior closing the mold. This has been a major “safety” concern in the industry for a long time. Until (and with the expense and its own safety issue) the advent of the robot, the common practice was to have with “safety switches” the labor/operator directly install the pieces by hand into either side of the mold cavities.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In one aspect, the innovation is the orientation/configuration of multiple segments of “living hinges” aligned such that they provide the required kinematic, controlled motion of associated members. An in plane forming action of the closure and normal operation of the tooling/mold/die to the part geometry is limited to only to shaping. Thus, the innovation facilitates multiple designed degrees of freedom that can be formed in the parts without the use of complicated forming techniques.

In another aspect of the innovation a flexible structure is disclosed and includes a plurality of members and a plurality of hinge sets, wherein a hinge set provides a connection between adjacent members. The hinge set includes a plurality of segment portions and a plurality of living hinges, wherein a first living hinge is disposed between one of the plurality of members and one of the plurality of segment portions, a second living hinge is disposed between the one of the plurality of segment portions and another one of the plurality of segment portions, and a third living hinge is disposed between the another one of the plurality of segment portions and another of the plurality of members.

In yet another aspect of the innovation when the plurality of hinges sets are in an extended position, a plane defined by a face of each of the plurality of segment portions is essentially parallel to a longitudinal axis of the plurality of members.

In still yet another aspect of the innovation when the plurality of hinge sets are in a closed position, a plane defined by a face of each of the plurality of segment portions is essentially perpendicular to a longitudinal axis of the plurality of members

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a perspective view of an example frame type structure incorporating the innovative living hinge in accordance with an aspect of the innovation.

FIG. 2A is a close-up perspective view of an example hinge set that includes at least one living hinge in accordance with an aspect of the innovation.

FIGS. 2B-2D are close-up top views of the example hinge set that includes at least one living hinge in accordance with an aspect of the innovation.

FIGS. 3A and 3B are perspective views of the example structure of FIG. 1 in a collapsed position in accordance with an aspect of the innovation.

FIGS. 4 and 5 are close up views of the hinge set of the structure of FIG. 1 in accordance with an aspect of the innovation.

FIGS. 6-10B are illustrations of another example embodiment of a structure incorporating the innovative living hinge in accordance with an aspect of the innovation.

FIG. 11 is a process flow chart illustrating a method of making the innovative living hinge in accordance with the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

The innovation overcomes conventional living hinges by facilitating a kinematic action of plastic molded members for controlled movement in any direction or axis of freedom while minimizing an increase in production costs (e.g., requirement of additional parts, re-tooling costs, etc.).

In one aspect of the innovation, disclosed herein is a “living” or “mechanical” hinge so aligned and spaced that it provides a kinematic desired of an intended design. When multiple living hinges are utilized, the axis of the living hinges and the angles between them work together to provide both an intended “degrees of freedom” and will constrain the motion to a “controlled” geometry. The result can be as simple as using three hinges at 45 degrees of axis alignment to each other to produce a perpendicular to axis final resultant swing motion or as complicated as using multiple (more than three) hinges at various angles to produce initial swing motion perpendicular to the axis morphing into parallel to axis motions. So it is in designing both the hinge placements and their respective angles to each other that the ultimate resultant paths of the attached members follow.

Other factors affecting this action include (but are not limited to); friction in the hinge (material hysteresis or drag), distance and forcing members or outside influences to the members involved in the motion, gravity and changing directions of the members in the applicable force field, other interactive forces designed as part of the intended action of the members.

One example application of the development of the innovation is a grouping of blow molded members joined together to form a multiple position product supporting device (e.g., a plastic skid). Using three living hinges for each hinge set at each connection joint, the four hinge sets join four members to provide a linearly parallel, tightly packaged part that is moldable and shippable in this tightly packed space to minimize production and shipping costs. When deployed for use at the intended manufactures attaching location, the configuration allows a user to simply spread open the contiguous assembly without the required labor to complete the assembly process but while still providing the required large picture frame opened condition and shape to perform the function of supporting and protecting the product it is attached to.

It is to be understood that the innovation is not dependent on the number of members, the number of hinge sets, the number of living hinges or the number of segment portions. The innovation can be utilized on applications that require any number of members and, hence, hinge sets. Further, the number of living hinges in a given hinge set can vary from application to application. Still further, the number of living hinges may vary from hinge set to hinges on the same application (structure).

Other potential applications include (but are not limited to); transport tight and expand open structures or framing, caging or structure interior volume variability, multiple folded sequence designs for variable finished position obtainment. These applications may include (but are not limited to); temporary structures such as tents, collapsible/insert-able/extendable protection caging systems for vehicles, tunnels, mines, etc . . . , constraining frame for expandable fluid containers, folding table structures, folding scaffolding, and many other flexible position member location based designs.

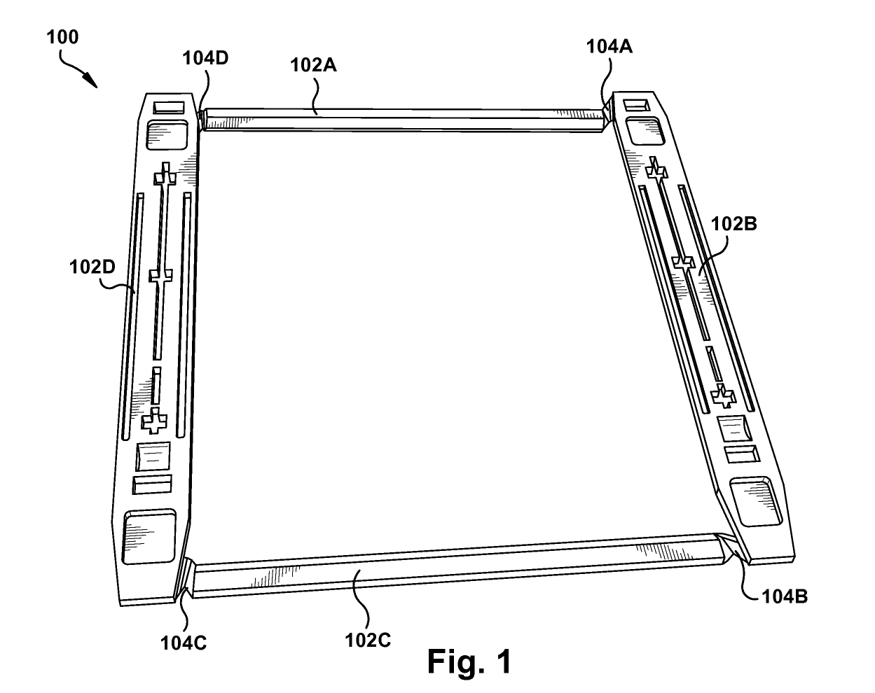

With reference now to the figures, FIG. 1 is a perspective view of an example frame type structure 100 incorporating the innovative living hinge in accordance with an aspect of the innovation. The example structure 100 includes multiple members 102A-102D (collectively 102 where appropriate) where the ends of each member 102A-102D are connected by a hinge set (joint connection) 104A-104D (collectively 104 where appropriate). Each hinge set 104A-104D includes at least one living hinge, as will be described further below. The living hinge(s) facilitate a flexible-kinematic action of moving the members 102A-102D in a controlled motion along a hinge axis with the required path of motion of the members.

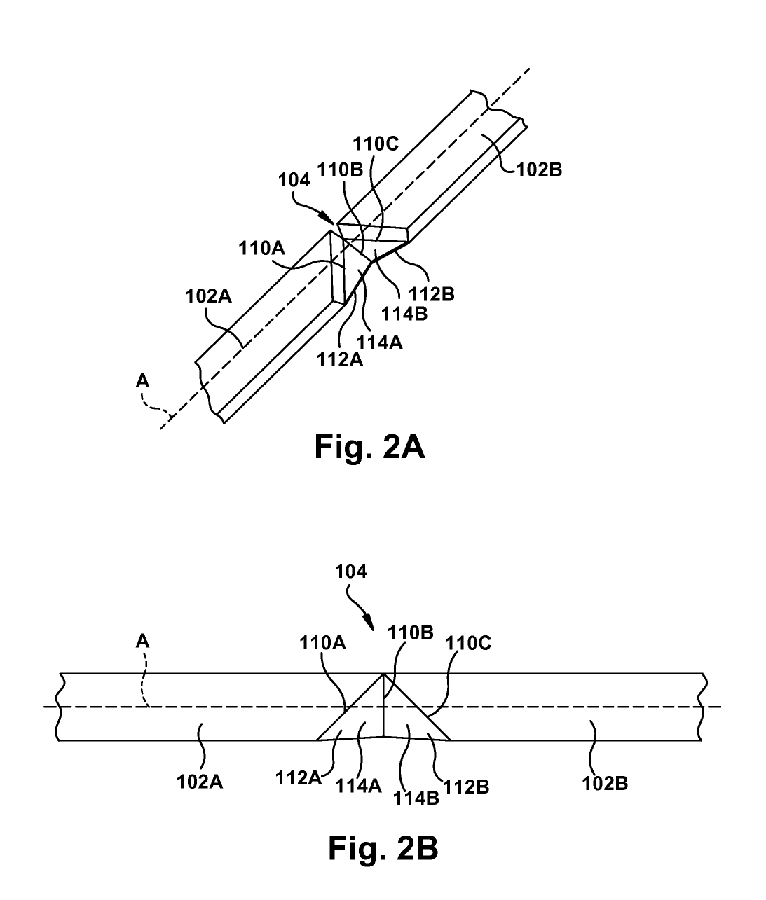

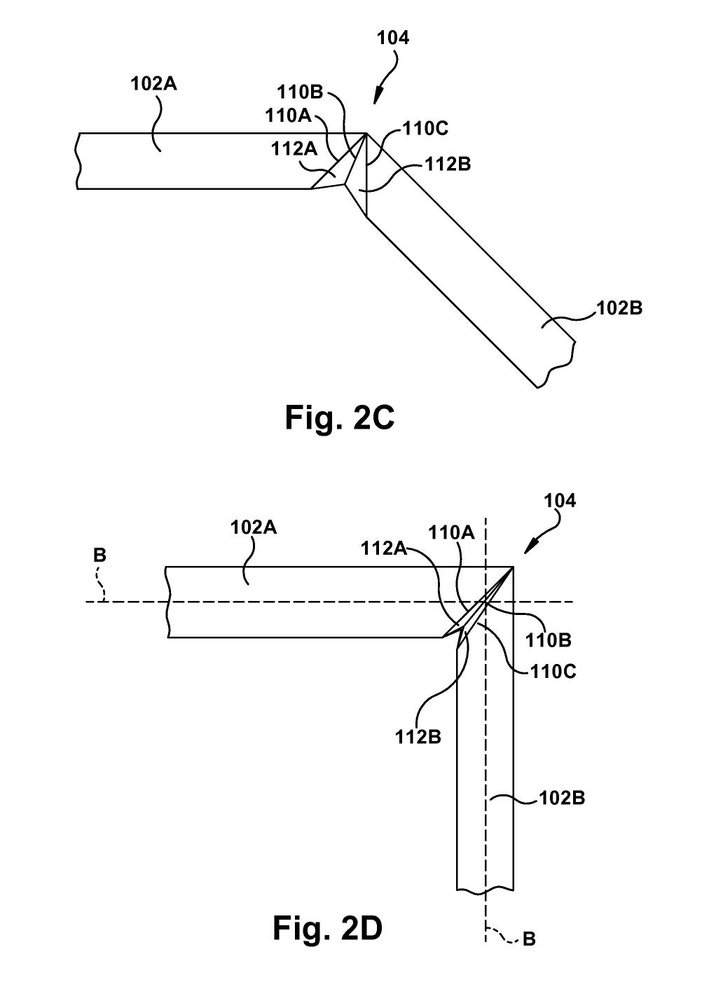

FIG. 2A is a close-up perspective view and FIGS. 2B-2D are close-up top views of an example hinge set 104 that includes at least one living hinge in accordance with an aspect of the innovation. FIGS. 2A and 2B illustrate the hinge set 104 in an extended (open) position, FIG. 2C illustrates the hinge set 104 in a partially extended (partially open) position, and FIG. 2D illustrates the hinge set 104 in a collapsed (closed) position.

The hinge set 104 includes at least one living hinge 110A, 110B, 110C (collectively 110 where appropriate) where adjacent living hinges 110 are separated by a segment portion 112A, 112B (collectively 112 where appropriate). It is to be understood that the innovation disclosed herein is not dependent on the number of living hinges 110 included in a hinge set 104. For example, the number of living hinges can range from one living hinge to any number of living hinges (e.g., 110A . . . 110N). Consequently, the number of segment portions separating the living hinges will range from zero (e.g., in applications where one living hinge is provided between two members) to one less than the number of living hinges (e.g., 110A . . . 110N-1). For simplicity, the example embodiment illustrated in FIGS. 2A-2D includes three living hinges. Thus, the example embodiment disclosed herein and illustrated in the figures is for illustrative purposes only and is not intended to limit the scope of the innovation.

The hinge set 104 and hence the living hinges 110, provide a connection between members 102A, 102B, as illustrated in the figures. Specifically, a first living hinge 110A provides a connection between a first member 102A and a first segment portion 112A, a second living hinge 112B provides a connection between the first segment portion 112A and a second segment portion 112B, and a third living hinge 110C provides a connection between the second segment portion 112B and a second member 102B.

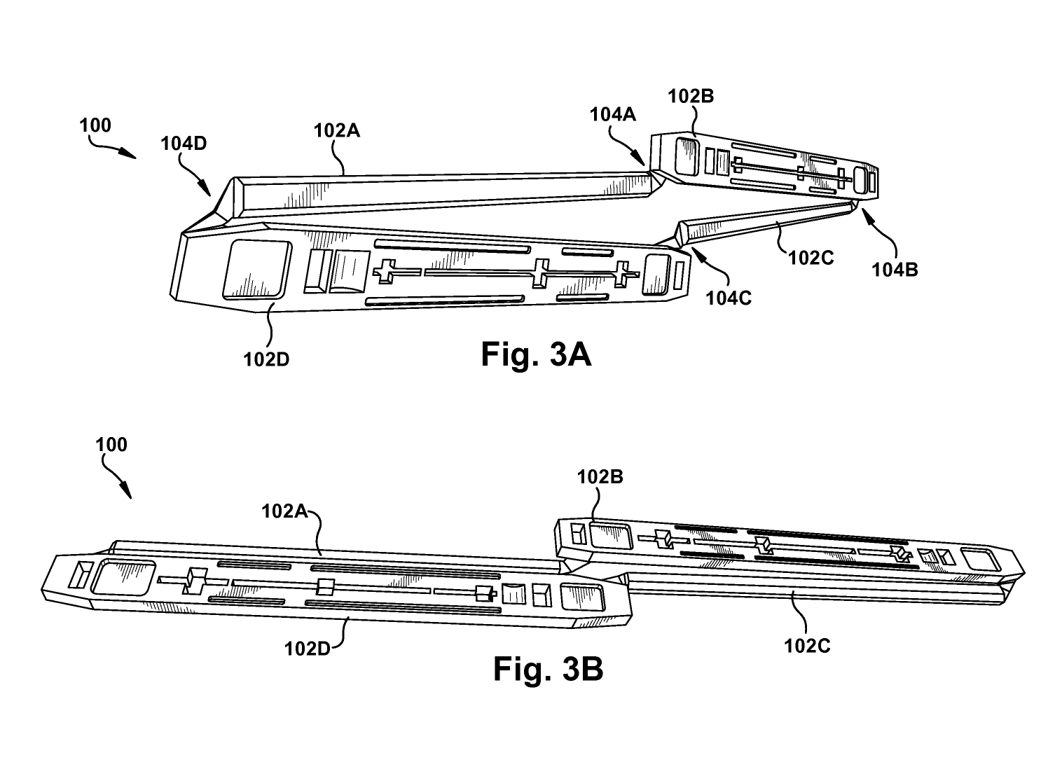

As mentioned above, FIGS. 2A and 2B illustrate the hinge set (connection joint) 104 in an extended (open) position. In this position, the first and second members 102A, 102B are essentially on the same axis A of approximately 180 degrees (as shown in FIGS. 3A and 3b, connected members may also be substantially parallel to each other but not on the same axis). In this open position, a plane defined by a face 114A of the first segment portion 112A and a plane defined by a face 114B of the second segment portion 112B are nearly parallel with the axis A formed by the first and second members 102A, 102B.

FIG. 2C illustrates the hinge set 104 in a partially extended (partially open or closed) position. In this position, the angle between the first and second members 102A, 102B is between 90 and 180 degrees. In addition, as illustrated in FIG. 2C, the faces 114A, 114B of the first and second segments 112A, 112B begin to collapse or fold in on each other as the first and second members 102A, 102B are rotated from the extended position to the closed position.

FIG. 2D illustrates the hinge set 104 in a collapsed (closed) position. In this position, the angle between the first and second members 102A, 102B is approximately 90 degrees. In addition, as illustrated in FIG. 2D, the faces 114A, 114B of the first and second segments 112A, 112B are facing each other such that the plane defined by the faces 116A, 116B of the first and second members 102A, 102B are essentially perpendicular to a longitudinal member axis B where adjacent longitudinal axes B form the axis A defined by two adjacent members 102 when the hinge set 104 is in the extended position.

The living hinge 110 configuration above allows the first and second members 102A, 102B to rotate through an angle of approximately 90 degrees while simultaneously bending to take up the compression of the plane of the initial position of the first and second segment portions 112A, 112B. In addition, when the hinge set 104 is in the partially extended position, as shown in FIG. 2C, the living hinge(s) 110 provide a degree of control of the motion of the first and second members 102A, 102B to each other.

When the first and second members 102A, 102B are in the closed position, as shown in FIG. 2D, the living hinge(s) 110 are such that they provide a good out of axis resistance to motion of various force inputs on the first and second members 102A, 102B. In addition, in the closed position, the first and second segment portions 112A, 112B are at an angle of approximately 90 degrees to the first and second members 102A, 102B respectively. This configuration allows the entire assembly to resist forces into and out of a plane defined by the structure.

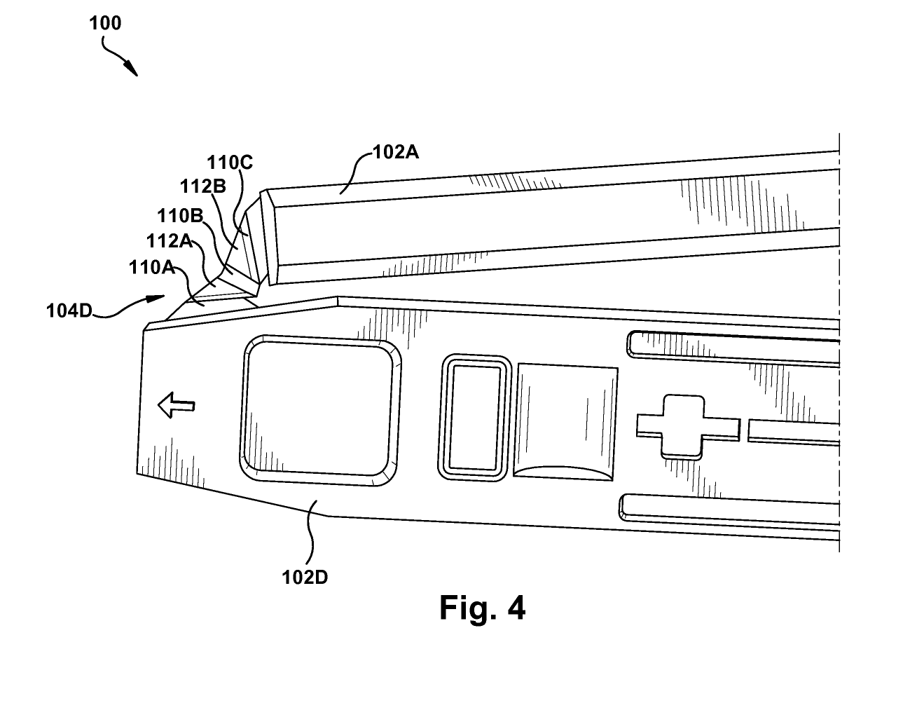

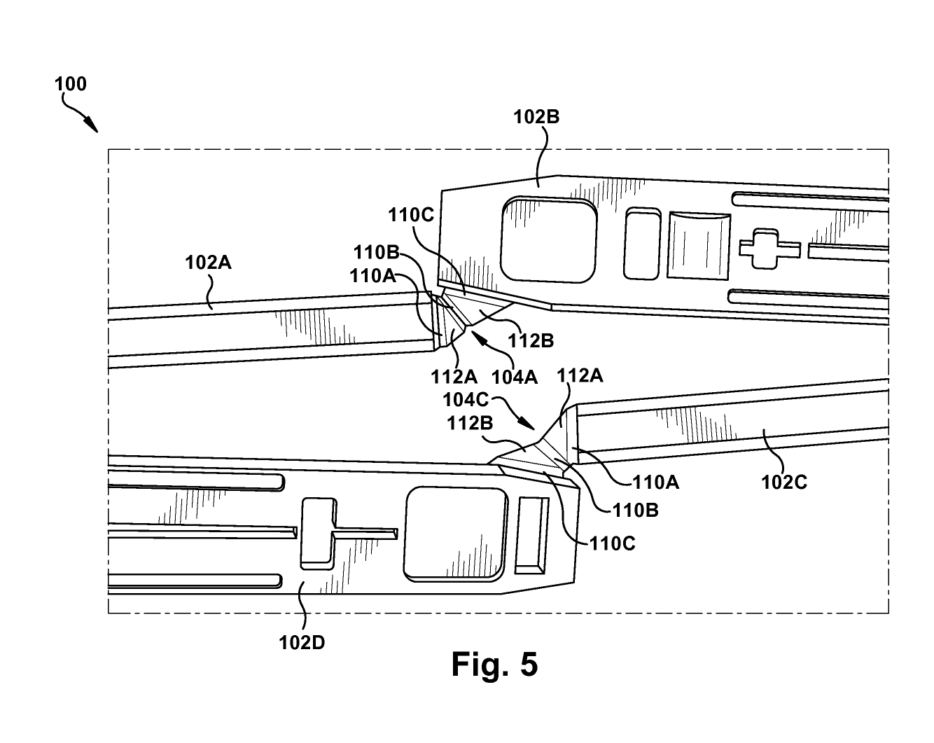

Referring back to FIG. 1 and to FIGS. 3A, 3B, 4, and 5, FIGS. 3A and 3B are perspective views of the example structure 100 shown in FIG. 1 in accordance with an aspect of the innovation. Specifically, FIGS. 3A and 3B are illustrations of the structure 100 shown in FIG. 1 showing the structure in a collapsed (or folded) position. In this position, the hinge sets 104 are in the extended or open position. The innovative living hinge(s) 110 facilitates the collapse of the structure 100 for storage and/or shipping purposes. FIGS. 4 and 5 are close up views of the hinge set 104D, 104A, and 104C respectively when the structure is in the collapsed position, as shown in FIGS. 3A and 3B.

Additional features such as snap locks, indents, protrusions can be integrated into the design of the innovation to provide additional structural stability and force resistance.

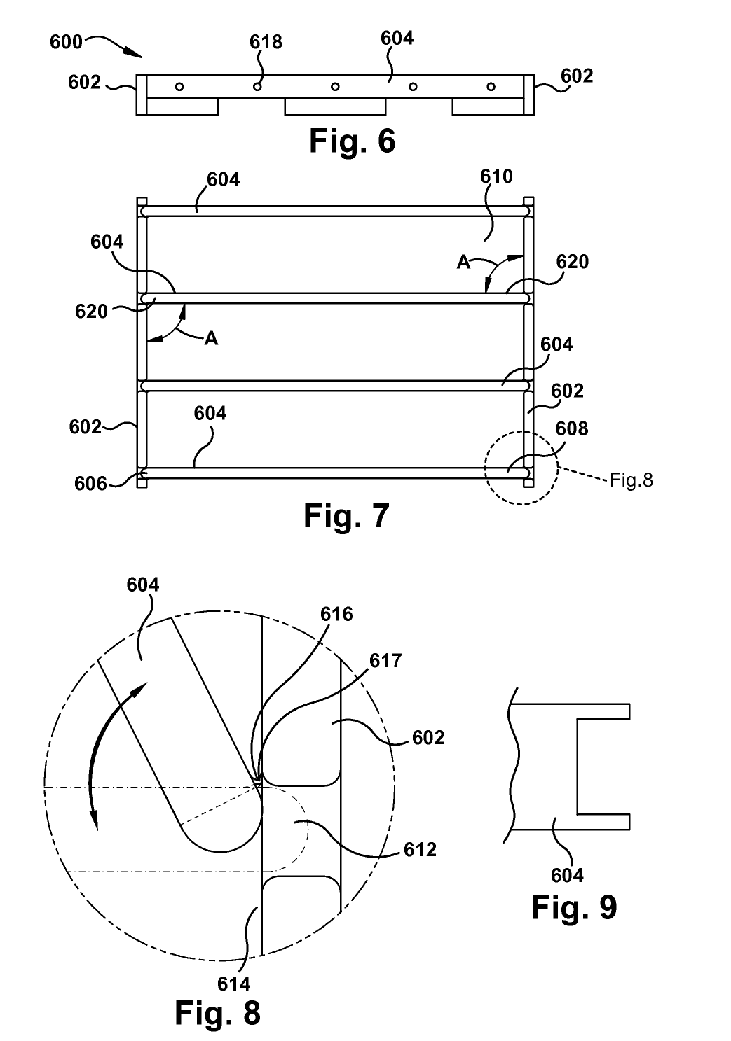

FIGS. 6-10B are illustrations of another example embodiment of a structure 600 incorporating the innovative living hinge in accordance with an aspect of the innovation. The structure 600 includes a plurality of members including a pair of oppositely disposed end beams (members) 602, multiple cross beams (members) 604 having a first end 606 and a second end 608 connected to the end beams 602, and a flexible material 610 that covers a top of the structure 600. The structure 600 illustrated in the figures is an example skid utilized for transporting a product or products. It is to be understood that the structure is not limited to a skid. Thus, the example embodiment illustrated in the figures is for illustrative purposes only and is not intended to limit the scope of the innovation.

Multiple notches 612 are defined along an inside face 614 of each end beam 102, best shown in FIG. 8. The notches 612 are adapted to receive the first and second end 606, 608 of each cross beam 604. The notches 612 illustrated in the figures are semi-circular in shape. It is to be understood, however, that the shape of the notches can be any shape, such as but not limited to, square, rectangular, triangular, etc.

The cross beams 604 are spaced apart and extend between each end beam 602, as shown in FIG. 7. Specifically, both the first and second end 606, 608 of each cross beam 604 extends into the notches 612 defined on the inside face 614 of the end beam 602 when in an unfolded (useable or open) position shown in FIG. 7. Both the first and second end 606, 606 of each cross beam 604 are pivotally connected to the end beam 602.

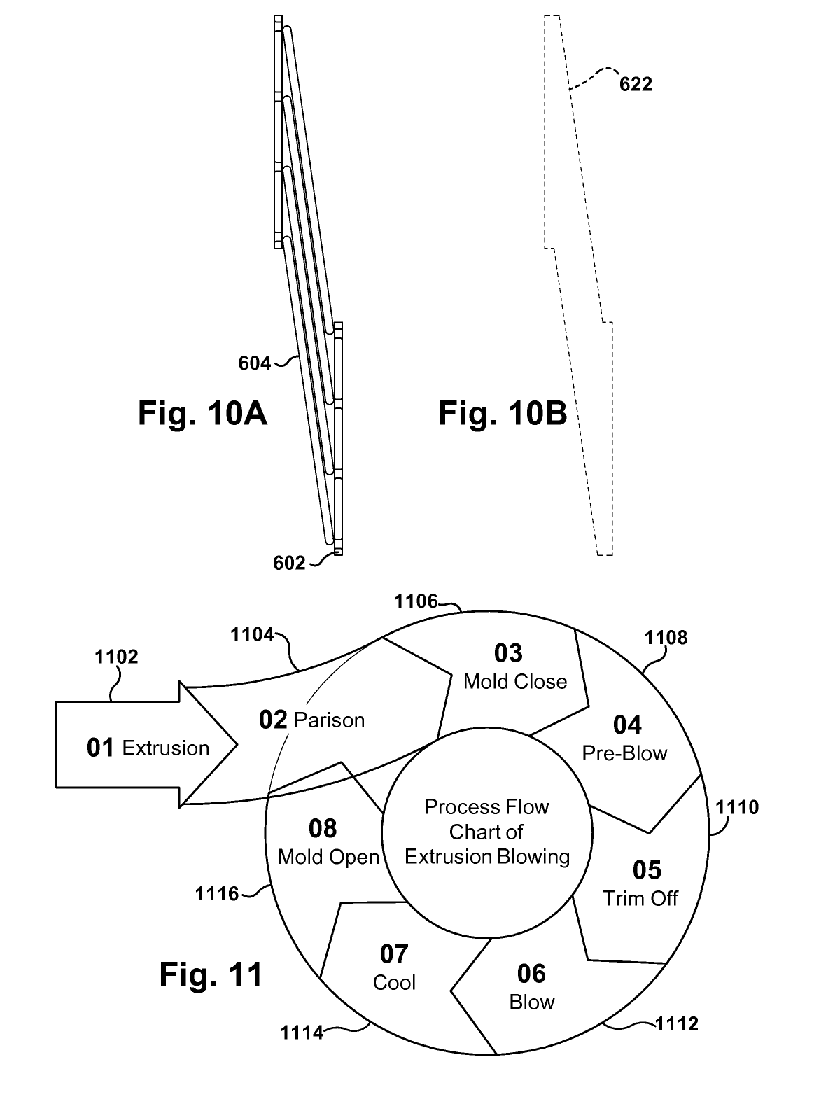

As shown in FIG. 8, a living hinge 616 provides a connection at a connection point 617 between the first end 606 of the cross beam 604 and one end beam 602 and between the second end 608 of the cross beam 604 and the opposite end beam 604. Thus, two living hinges 616 are provided for each connection of a cross beam 104 to the opposite end beams 102. The two living hinges 616 are disposed on diagonally opposite ends of the cross beams 604 from each other. The living hinge 616 facilitates a pivot action between the end beams 602 and the cross beams 604 such that the structure 600 can be configured in a folded (stored or shipping) position, as shown in FIG. 10A.

An angle ‘A’ is defined between a hinged side edge 620 at each end of each cross beam 604 and each end beam 602. When the structure 600 is in an open position, as shown in FIG. 7, the angle ‘A’ between the hinged side edge 620 of each of the plurality of cross beams 604 and each of the pair of end beams 602 is essentially 90 degrees. When the structure 600 is in the folded position the angle ‘A’ between the hinged side edge 620 of each of the plurality of cross beams 604 and each of the pair of end beams 602 is less than 90 degrees.

The flexible material 610 may be made of any suitable material, such as but not limited to, a polymer, plastic, etc. The flexible material 610 covers a top of the structure 600 to prevent any product from falling through the structure 600 due to the spacing of the cross beams 604. The flexible material 610 can attach to the end beams 602 and cross beams 604 with fasteners 618, such as but not limited to, screws, rivets, hook and loop, etc.

As mentioned above, the living hinge 616 allows the structure 600 to be manipulated from an unfolded position, shown in FIG. 7 to a folded (or collapsed) position, shown in FIG. 10A. This configuration has several advantages. First, storing and transporting the structure 600 in the folded position requires less space. Second, molds to form the structure can be configured to produce the structure 600 in the folded position, see FIG. 10B. Producing the structure 600 in the folded position reduces the amount of material the structure requires. Thus, there is less waste that requires reprocessing, thereby increasing efficiency and reducing production costs.

In addition, a bulge or shaping can be applied as needed to allow for a correctly shaped cross member to allow for a secondary process (in mold or out of mold) that indents this bulge into the blown member itself. The resulting shaping allows both part walls of the material to bend together with a radius having a size that facilitates the reduction of point stress, thus, increasing the longevity of the hinge.

Still further, the shaping and double wall stock forms a spherical shape, which aids in the overall strength and stiffness of the living hinge. This feature provides flexibility and strength to thereby allow the skid to flex between the unfolded and folded positions, as well as allowing the skid to be self-supporting.

It is to be understood that the innovation is not dependent on the number of members, the number of hinge sets, the number of living hinges or the number of segment portions. The innovation can be utilized on applications that require any number of members and, hence, hinge sets. Further, the number of living hinges in a given hinge set can vary from application to application. Still further, the number of living hinges may vary from hinge set to hinges on the same application (structure).

Referring to FIG. 11, a method of manufacturing the structure incorporating the innovative living hinge will now be described via a blow molding process. At 1102 and 1104, the material is melted and extruded into a hollow tube (parison). At 1106, the parison is inserted into a mold and the mold is closed. The mold has a shape that includes the entire structure including the members and the multiple living hinges described herein. In addition, the cavity of the mold has a shape such that the structure is formed in a folded or collapsed state, as shown in FIG. 10B. At 1108, a pre-blow is performed where air is blown into the parison to partially inflate it into the desired shape, such as the structure including the living hinge disclosed herein. At 1110, the excess material is trimmed away. At 1112, a final blow is performed to fully inflate the parison into the desired shape. At 1114, the mold is cooled to a predetermined temperature. At 1116, the mold is opened and the final structure is removed.

An advantage to the innovative living hinge is that the living hinge can be molded in as part of the same parison that is already in place to form the structure. Thus, the living hinge is included as part of the structure during the molding process. This allows for a dynamic structure (structure that has moving parts with respect to each other) to be molded as a single unit without any additional tooling and/or costs, thus, overcoming a processing disadvantage discussed above.

Another advantage is that the required shaping does not eliminate the use of most if not all “in-mold” de-flashing or gate trim mechanisms, which is important in processing steps 1106, 1114 and 1116. In addition, due to the general form and dynamics of the innovation, the mold cavity has an optimal size that facilitates allows for a higher parts per process cost reduction. In other words, since the structure is a dynamic structure, the structure can be molded in the folded or collapsed state (see FIGS. 3A and 10). Thus, for example the cavity of the mold would have the shape as the outlined shape 622 in FIG. 10B for the second embodiment. This reduces the amount of material that needs to be trimmed during the manufacturing process. In turn, since the amount of waste is reduced so is the amount of material that needs to be recycled thereby reducing recovery/production costs.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flexible structure comprising:
a plurality of members; and
a plurality of hinge sets, wherein a hinge set provides a connection between adjacent members, the hinge set including:
a plurality of segment portions; and
a plurality of living hinges, wherein a first living hinge is disposed between one of the plurality of members and one of the plurality of segment portions, a second living hinge is disposed between the one of the plurality of segment portions and another one of the plurality of segment portions, and a third living hinge is disposed between the another one of the plurality of segment portions and another of the plurality of members.

2. The flexible structure of claim 1, wherein when the plurality of hinges sets are in an extended position, a plane defined by a face of each of the plurality of segment portions is essentially parallel to a longitudinal axis of the plurality of members.

3. The flexible structure of claim 1, wherein when the plurality of hinge sets are in a closed position, a plane defined by a face of each of the plurality of segment portions is essentially perpendicular to a longitudinal axis of the plurality of members.

4. The flexible structure of claim 1, wherein when the structure is in a collapsed state a first member from the plurality of members and a second member from the plurality of members form an axis of approximately 180 degrees.

5. The flexible structure of claim 4, wherein a plane defined by a face of a first segment portion from the plurality of segment portions and a plane defined by a face of a second segment portion from the plurality of segment portions are essentially parallel to the axis formed by the first member and the second member.

6. The flexible structure of claim 1, wherein when the structure is in a non-collapsed state, a plane defined by a face of a first segment portion from the plurality of segment portions and a plane defined by a face of a second segment portion from the plurality of segment portions are essentially perpendicular to a longitudinal axis of the first member and the second member respectively.

7. The flexible structure of claim 6, wherein when the structure is in a non-collapsed state, the plane defined by the face of the first segment and the plane defined by the face of the second segment face each other.

8. a flexible structure comprising:
a plurality of members; and
a plurality of living hinges providing pivoting connections between the plurality of members,
wherein the plurality of members includes:
a pair of end members;
a plurality of cross members extending between the pair of end members and being pivotally connected to the pair of end members.

9. The flexible structure of claim 8, wherein the plurality of living hinges are disposed on diagonally opposite ends of each of the plurality of cross members.

10. The flexible structure of claim 9, wherein the plurality of living hinges are pivotally connected between the pair of end beams and the plurality of cross members at a connection point.

11. The flexible structure of claim 10, wherein an angle between a hinged side surface of each of the plurality of cross beams and the each of the pair of end beams is essentially 90 degrees when the flexible structure is in an unfolded position.

12. The flexible structure of claim 10, wherein an angle between a hinged side surface of each of the plurality of cross beams and the each of the pair of end beams is less than 90 degrees when the flexible structure is in a folded position.

13. The flexible structure of claim 8, wherein each of the pair of end members includes a notch defined on an inside face of the each of the pair of end members.

14. The flexible structure of claim 13, wherein each end of each cross beam extends into a corresponding notch on each of the pair of end beams when the flexible structure is in an open position.

15. The flexible structure of claim 8 further comprising a flexible cover that covers a top of the flexible structure and being attached to each of the pair of end beams and each of the plurality of cross beams.

16. A method of manufacturing a flexible structure comprising:
melting material;
extruding the material into a hollow tube;
providing a mold having a cavity that incorporates all moving parts of the structure;
blowing air into the hollow tube to partially form the flexible structure;
trimming away excess material;
blowing air into the hollow tube to fully form the flexible structure;
cooling the mold;
removing the flexible structure from the mold.

17. The method of claim 16, wherein the mold has a shape such that the flexible structure is formed in a folded state.

18. The method of claim 16, wherein the flexible structure includes a plurality of members and a plurality of hinge sets that provide a connection between adjacent members.

19. The method of claim 18, wherein the plurality of hinge sets include a plurality of segment portions and a plurality of living hinges.

20. The method of claim 18, wherein a first living hinge is disposed between one of the plurality of members and one of the plurality of segment portions, a second living hinge is disposed between the one of the plurality of segment portions and another one of the plurality of segment portions, and a third living hinge is disposed between the another one of the plurality of segment portions and another of the plurality of members.
